(19) United States
(12) Patent Application Publication
(10) Pub. No.: US 2008/0010554 A1
(43) Pub. Date: Jan. 10, 2008

(54) System for prechecking corrective actions on parameterable elements causing problems in a communicating network

(75) Inventors: Arnaud Gonguet, Paris (FR); Gerard Delegue, Cachan (FR); Stephane Betge-Brezetz, Paris (FR); Julien Robinson, Paris (FR); Lionel Fournigault, Gif Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/252,731

(22) Filed: Oct. 19, 2005

(30) Foreign Application Priority Data
Oct. 20, 2004 (FR) 0411178

(51) Int. Cl. G06F 11/00

(52) U.S. Cl. 714/47

(57) ABSTRACT

A system is dedicated to checking corrective actions intended for parameterable elements of a radio communication network, comprising an information base for storing primary data representing values of managed parameters of the elements and of a topology of the network, a rules base for storing data representing rules for checking appropriate parameter setting of the elements, processing means for making, in the event of reception of a designation of at least one parameterable element of the network causing a problem in the network and data representing at least one corrective action to be applied to the designated element, a local copy of a portion of the primary data stored in the information base and representing the designated element, elements adjacent thereto and the topology associated with the designated and adjacent elements, and checking means for applying at least certain of the rules to the local copy taking account of each designated corrective action in such a manner as to determine the influence of each designated corrective action on the designated and adjacent elements and to deliver a message including data representing the influence.

### CROSS-REFERENCE TO RELATED APPLICATIONS

This application is based on French Patent Application No. FRO411178 filed Nov. 20, 2004, the disclosure of which is hereby incorporated by reference thereto in its entirety, and the priority of which is hereby claimed under 35 U.S.C. §119.

### BACKGROUND OF THE INVENTION

1. Field of the Invention

The invention relates to cellular (or mobile) communication networks and more precisely to solving problems introduced by parameterable elements of such networks.

In the present context, the expression “parameterable element” refers to any component of a network whose functioning can be managed, that is to say configured, by a network manager of a cellular communication network (or, more simply, a radio network), such as a network management system (NMS), for example. Thus the element may be, for example, a cell in which mobile communication terminals can set up calls or a network equipment such as a router or a base station.

In the present context, the expression “radio network” refers to any type of cellular communication network and in particular those of type 2G (such as GSM type networks), type 2.5G (such as GPRS and EDGE networks), or type 3G (such as UMTS, 4G, WIFI and WIMAX networks).

2. Description of the Prior Art

Parameterable elements of radio networks are the origin of problems and malfunctions that compromise good functioning thereof and in particular compliance with the quality of service covered by service level agreements (SLA) between network operators and their clients. Of these problems and malfunctions, an excessive call drop rate may be cited, for example.

To determine the root cause of a problem or malfunction, and where applicable to propose corrective action, network operators use optimization tools that are generally integrated into the network management system (NMS) of their network. For example, such tools are based on a causal diagram describing all possible causes of a problem, then the causes of those causes, and so on, as far as one or more root causes.

For example, the root cause of an excessive call drop rate may be a problem with handover (uninterrupted intercellular transfer).

A corrective action generally entails modifying or adapting one or more parameters of one or more parameterable elements associated with a root cause. If the tool determines a plurality of corrective actions, it is usually the operator who selects the one to be effected in his network.

Radio networks becoming increasingly more complex and including increasingly greater numbers of parameterable elements and interactions between technologies (for example EDGE, UMTS and WiFi) becoming increasingly numerous, the corrective actions effected at the level of a parameterable element frequently induce “collateral” problems or malfunctions at the level of adjacent parameterable elements. In other words, a corrective action intended to remedy one problem frequently induces one or more other problems or malfunctions. Now, basic verification methods cannot detect “collateral damage” caused by numerous corrective actions.

To solve this problem it is undoubtedly possible to construct an extensive simulator describing not only the whole of the topology of the network but also all types of parameterable elements and all their interactions. However, a simulator is this kind is particularly difficult to produce and therefore particularly costly, and the processing time that it needs to effect an extensive prediction of the effects of a corrective action is incompatible with the time available to a network manager to remedy a problem or malfunction.

An object of the invention is thus to improve on this situation of no prior art tool proving entirely satisfactory.

### SUMMARY OF THE INVENTION

To this end the invention proposes a system for checking corrective actions intended for parameterable elements of a radio communication network, comprising an information base for storing primary data representing values of managed parameters of the elements and of a topology of the network, a rules base for storing data representing rules for checking appropriate parameter setting of the elements, processing means for making, in the event of reception of a designation of at least one parameterable element of the network causing a problem in the network and data representing at least one corrective action to be applied to the designated element, a local copy of a portion of the primary data stored in the information base and representing the designated element, elements adjacent thereto and the topology associated with the designated and adjacent elements, and checking means for applying at least certain of the rules to the local copy taking account of each designated corrective action in such a manner as to determine the influence of each designated corrective action on the designated and adjacent elements and to deliver a message including data representing the influence.

The checking device of the invention may have other features, which may be used separately or in combination, and in particular:
its processing means may send the control means the local copy integrating each designated corrective action,
a memory may be coupled to the processing means for storing a current local copy consisting of the local copy integrating each designated corrective action, and where applicable the local copy initially constituted, before integration of each designed corrective action,
in the event of reception of data representing at least one new corrective action to be applied to the designated elements taking account of the current local copy, its processing means may extract the current local copy from the memory in order to integrate each designated new corrective action therein before storing it in the memory and sending it to the checking means in order for them to determine the influence of each designated corrective action on the designated and adjacent elements,
in the event of reception of data representing at least one new corrective action to be applied to the designated element taking account of a local copy earlier than the current local copy, its processing means may extract from the memory the local copy earlier than the current local copy in order to integrate each designated new corrective action therein before storing it in the memory and sending it to the control means in order for them to determine the influence of each designated corrective action on the designated and adjacent elements,
in the event of reception of data representing at least one new corrective action to be applied to the designated element taking account of the initial local copy, its processing means may extract the initial local copy from the memory in order to integrate each new designated corrective action therein before sending it to the control means in order for them to determine the influence of each designated corrective action on the designated and adjacent elements,
its checking means may take the form of a rule engine,
at least certain of the corrective actions may consist of a parameter value to be substituted for a designated element parameter value in a local copy,
at least certain of the rules may take the form of a condition followed by a corrective action to be effected if the condition is satisfied.

The invention also proposes an optimization tool for setting parameters of parameterable elements of a radio communication network, the tool comprising an information base for storing primary data representative of the managed parameter values of the elements and of a topology of the network and diagnostic means for delivering designations of a cause of a problem occurring within the network and of at least one parameterable element of the network that is the cause of the problem and a checking system of the type described hereinabove coupled to the information base.

This tool may further comprise configuration means for generating commands representing at least one corrective action to be applied to the designated element checked by the checking device and causing no collateral damage to elements adjacent the designated elements to correct the cause determined by the diagnostic means.

The invention also proposes a network management system comprising an optimization tool of the type described hereinabove.

The invention further proposes a network management system comprising a conventional optimization tool connected to a checking system of the type described hereinabove.

Other features and advantages of the invention will become apparent on reading the following detailed description and examining the appended drawings.

### BRIEF DESCRIPTION OF THE DRAWINGS

FIG. 1 is a highly diagrammatic representation of a cellular communication network equipped with one embodiment of a checking device of the invention.

FIG. 2 is a diagram of one example of stringing corrective action tests leading to the determination of a series of corrective actions causing no collateral damage.

### DETAILED DESCRIPTION OF THE PREFERRED EMBODIMENT

The appended drawings constitute part of the description of the invention as well as contributing to the definition of the invention, if necessary.

An object of the invention is to enable rapid checking of the influence of actions intended to correct problems or malfunctions introduced into a cellular communication network by its parameterable elements with a view to determining a series of corrective actions to be applied to those parameterable elements that do not cause any collateral damage.

As indicated in the introductory part, the invention concerns any type of cellular communication network (referred to hereinafter as a radio network) and in particular those of type 2G (such as GSM type networks), type 2.5G (such as GPRS and EDGE networks) and type 3G (such as UMTS, 4G, WIFI and WIMAX networks).

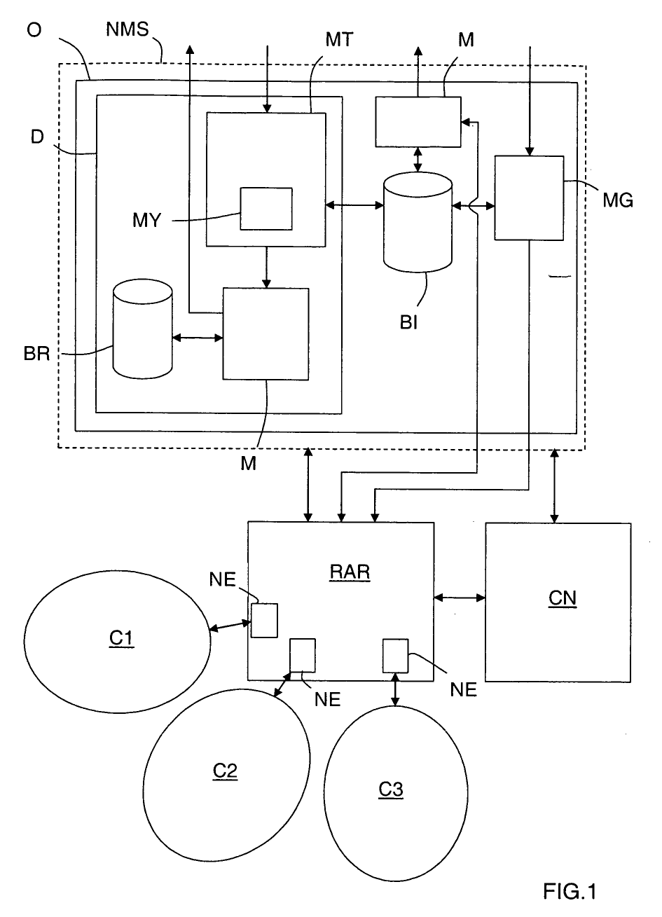

As the person skilled in the art knows, and as shown diagrammatically in FIG. 1 in a very diagrammatic form but nevertheless in sufficient detail to understand the invention, a radio network may be summarized as comprising a core network CN coupled to a radio access network RAR (which is called the UTRAN in the case of a UMTS network and the BSS in the case of a GSM network), in turn connected to a network management system NMS.

The radio access network RAR includes in particular a set of network equipments NE and in particular interconnected base stations (known as Nodes B in the case of a UMTS network and base transceiver stations (BTS) in the case of a GSM network) and radio network controllers or nodes (known as RNC in the case of a UMTS network and BSC in the case of a GSM network). The network management system NMS is also connected to the base stations via the radio network controllers.

Each base station (Node B or BTS) is associated with at least one cell Ci covering a radio area in which mobile terminals can set up (or continue) radio connections. Here the value of the suffix i is from 1 to 3, but it may take any non-zero value.

In the present context, the expression “mobile terminal” refers to any mobile or portable communication terminal capable of exchanging data in the form of radio signals either with another terminal or network equipment via their parent network or networks or with its own parent network. Thus a mobile terminal may be, for example, a mobile telephone, a desktop or laptop computer or a personal digital assistant (PDA) equipped with a radio communication module.

The core network CN includes in particular a set of network equipments (not shown) connected to the radio network controllers (RNC or BSC) and to the network management system NMS.

The cells Ci and the network equipments NE constitute parameterable elements of the radio network. In the present context, the expression “parameterable element” refers to an element that may be configured remotely by the network management system NMS and whose operation may also be managed (or supervised) remotely by said network management system NMS.

This management or supervision is based on indicators whose current values define at least partially the current state of certain equipments NE or elements Ci of the network, such as its cells, routers, base stations (Nodes B or BTS) and radio network controllers (RNC or BSC).

An indicator is not necessarily observed (or measured) directly at the level of a network equipment. Its current value is generally calculated from counter values collected from one or more network equipments and consolidated (or aggregated) at network level.

The cells Ci being immaterial elements, they are managed (or supervised) by indicators whose values are defined by counter values stored in the network equipments NE on which they depend.

Thus in the present context the term “indicator” refers to a variable whereof the value defines at least partially the current state of a parameterable element. It is the pass-band used, for example, the data packet drop rate or the number of calls set up.

Counter values (or, more generally, information) for calculating the indicator values are collected by means of a network manager that is generally installed in the network management system NMS.

To be more precise, the network manager is generally responsible for recovering at the level of the network equipments NE the current counter values that it stores and then consolidating its counter values in order to calculate the current values of the corresponding indicators in order to analyze them and then send the result of the analysis to the network operator.

For example, this analysis may consist in comparing the behavior of the parameterable element, as defined by the sets of indicator values obtained, to a behavior in normal operation as defined by a measurement profile, or by comparing the current value of an indicator of the parameterable element to an alarm threshold.

In the present context, the expression “measurement profile” refers to a set of at least one base line representative of the normal temporal revolution of an indicator over a selected period, for example one day, one week or one month.

Each set of indicator values obtained is compared value by value to the corresponding base line (or where applicable to an envelope) or to a threshold, for example. If at least one set of indicator values does not correspond to the corresponding base line or to the corresponding threshold, the diagnostic module MD delivers an alarm to inform the operator that the behavior of the designated parameterable element is abnormal.

The alarms may be forwarded to an optimization tool OO which may be installed in the network management system NMS, as shown here.

The optimization tool OO comprises a diagnostic module MD for determining the root cause or causes of a problem that has occurred at the level of the parameterable element (or, more simply, the element) designated in a received alarm message.

The diagnostic module MD may also determine each corrective action to be undertaken to remedy each root cause that has been determined.

Instead of this, or in addition to this, the operator can also determine each corrective action to be undertaken to remedy each root cause determined by the diagnostic module MD.

The invention is operative at this stage. Its object is to allow checking of the influence of each corrective action to be undertaken proposed by the operator and/or by the diagnostic module MD.

To this end, the invention proposes a system D responsible for checking the corrective actions to be applied to elements Ci, NE of the radio network.

As shown in FIG. 1, the checking system D may be part of the optimization tool OO. This is not obligatory, however. It may be part of the network management system NMS and coupled to its optimization tool OO or coupled to the network management system NMS and in particular to its optimization tool OO.

The checking system D of the invention comprises at least one processing module MT, one checking module MC and one rules base BR.

The processing module MT is coupled to an information base BI that is preferably installed in the optimization tool OO and which stores primary data representing all the data that can be manipulated of the parameterable elements Ci and NE of the network, for example the values of the managed parameters of the parameterable elements Ci and NE (counters/indicators and configuration parameters) and of a network topology.

This processing module MT accesses the information base Bi each time that it receives the designation of at least one element of the network causing a problem (or malfunction) within the latter and data representing at least one corrective action to be applied to that designated element.

This element designation and this action data are preferably sent by the operator, for example via a man/machine interface of the network management system NMS. However, a variant may be envisaged in which the element designation and the corresponding action data are supplied by the diagnostic module MD of the optimization tool OO.

Accessing the information base BI enables the processing module MT to make a local copy of a portion of the primary data that it stores, to be more precise the data representing the designated element and elements adjacent it, as well as the topology that is associated with the designated and adjacent elements. For example, the designated element is the cell C2 and the adjacent elements are the cells C1 and C3.

The checking system D preferably comprises a memory MY in which the processing module MT stores the local copy that it makes, referred to hereinafter as the initial local copy. As will emerge later, this enables the processing module MT, if necessary, to revert to the initial version of the local copy to integrate into it one or more new corrective actions to be checked without needing to access the information base again.

The memory MY may be part of the processing module MT, as shown here, but this is not obligatory.

The processing module MT integrates into the initial local copy at least one of the corrective actions defined by the received data that accompanies the designation of the element, for example the element C2, in order to constitute a “current” local copy.

Any type of corrective action may be envisaged. However, a corrective action generally takes the form of a configuration parameter value to be assigned to a designated element.

The processing module MT preferably stores in the memory MY each current local copy that it sends to the checking module MC. As will emerge later, this enables the processing module MT, if necessary, to revert to an earlier version of the current local copy to integrate therein one or more new corrective actions to be checked without needing to repeat all the actions previously effected that yielded that earlier version.

The checking module MC applies at least some of the rules that are stored in the rules base BR to which it is coupled to the current local copy that is sent to it by the processing module MT and integrates each latest designated (received) action.

The rules base BR stores data representing checking rules that correspond to appropriate parameter settings of at least one element Ci, NE. In the present context, the expression “appropriate parameter setting” refers to a configuration parameter value or a range of configuration parameter values that, when applied (or instigated) at the level of an element Ci, NE, enables it to function without this causing problems or malfunctions at the level of adjacent elements.

For example, each rule takes the form of a condition followed by an action to be effected if that condition is satisfied: “if <condition> then (<action>)”. In the present context a condition is a binary test for verifying that a test configuration parameter (defined by a corrective action) belongs to a predetermined range of “acceptable” values.

A checking rule may take the following form, for example: “if the number of adjacent cells is strictly greater than five (5), then the maximum number of adjacent cells of one of the adjacent cells is equal to four (4)”.

Another checking rule may take the following form, for example: “if the condition is true then P3=P1+P2”, where P1, P2 and P3 are parameter values, and “if P3 is strictly greater than 5, then P3 is too large”. In the present context, as soon as P1 and/or P2 is/are modified, the information base BI is modified to reflect the new value of P3.

The checking rules being generic, the checking module MC applies them to each current local copy. Accordingly, each parameter value belonging to the current local copy may be checked by means of checking rules from the rules base BR. To this end, the checking module MC takes the form of a rule engine, for example.

If a tested configuration parameter belongs to the intended range of acceptable values, this indicates that the associated corrective action does not cause any collateral damage at the level of the elements adjacent the designated element, because of a problem detected by the diagnostic module MD. In this case, the checking module MC supplies the operator with a message reporting that the corrective action may be effected with no risk of influencing the operation of at least one element adjacent the designated element, The operator can then, if appropriate, check the influence of a new corrective action on the element initially designated, should this prove necessary. A new corrective action may be cumulative with one or more preceding corrective actions.

On the other hand, if a tested configuration parameter does not belong to the intended range of acceptable values, this indicates that the associated corrective action causes collateral damage at the level of one or more elements adjacent the designated element, because of a problem detected by the diagnostic module MD. In this case, the checking module MC delivers to the operator a message reporting that the corrective action cannot be effected and the reason or reasons for this. The operator can then check the influence of a new corrective action on the element initially designated. This new corrective action may be cumulative with one or more preceding corrective actions, so enabling an edge effect to be corrected, for example. If the analysis of the influence of a configuration parameter value (integrated into a local copy) by means of rules stored in the rules base BR, leads to a result that is neither yes (“OK”) nor no (“NOK”), the message may explain a problem, for example an edge effect, not in order for some other corrective action to be proposed, but in order for complementary actions to eliminate said problem.

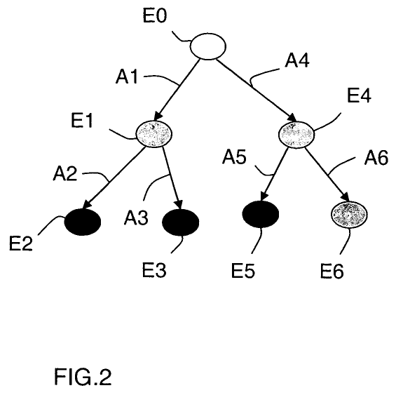

FIG. 2 is a diagram of one non-limiting example of the stringing of checks (or verifications) of corrective actions leading to the determination of a series of corrective actions causing no collateral damage.

To be more precise, in this example, the operator wishes to check the influence of two types of corrective action on elements, for example the elements C1 and C3, adjacent a designated element, for example the element C2. It therefore instructs the processing module MT to check the influence of a first action A1, representative of a first type of action, on the elements C1 and C3 adjacent the designated element C2.

The processing module MT then accesses the information base BI in order to make an initial local copy, indicated by a white ellipse E0, which it stores in the memory MY, and adapted to the designated element C2 and the elements C1 and C3 adjacent it. The processing module MT then integrates into the initial local copy E0 a first action A1, which yields a first current local copy, shown by a gray ellipse E1, which it also stores in the memory MY and sends to the checking module MC.

The checking module MC tests the first current local copy El, and in particular the first action A1. Here it is considered that this first action A1 does not influence the elements C1 and C3 adjacent the designated element C2.

The operator then instructs the processing module MT to check the influence of a second action A2, representative of a second type of action, on the elements C1 and C3 adjacent the designated element C2.

The processing module MT then accesses the memory MY in order to recover the current local copy E1 that it stores and then integrates therein the second action A2 (complementing the first action A1), which produces a second current local copy, shown by a black ellipse E2, which it also stores in the memory MY and sends to the checking module MC.

The checking module MC checks the second current local copy E2, and in particular its second action A2. Here it is considered that this second action A2 influences the elements C1 and C3 adjacent the designated element C2. The checking module MC reports this influence to the operator, together with its cause or causes.

The operator then determines a third action A3, representative of the second type of action and which he hopes will have no influence on the adjacent elements C1 and C3. He then instructs the processing module MT to check the influence of this third action A3 on the elements C1 and C3 adjacent the designated element C2.

The processor module MT then accesses the memory MY in order to recover the local copy E1, earlier than the current copy E2, which it stores. It then integrates into it the third action A3 (complementing the first action A1), which produces a third current local copy, shown by a black ellipse E3, which it also stores in the memory MY and sends to the checking module MC.

The checking module MC checks the third current local copy E3, and in particular its third action A3. Here it is considered that this third action A3 also influences the elements C1 and C3 adjacent the designated element C2. The checking module MC reports this influence to the operator, together with its cause or causes.

The operator having no alternative to corrective action of the second type, he then determines a fourth corrective action A4 of the first type as an alternative to the first action A1 and that he hopes will have no influence on the adjacent elements C1 and C3.

The operator then instructs the processing module MT to check the influence of the fourth action A4 on the elements C1 and C3 adjacent the designated element C2.

The processing module MT then accesses the memory MY in order to recover the initial local copy E0 that it stores and then integrates into it the fourth action A4, which produces a fourth current local copy, shown by a gray ellipse E4, which it also stores in the memory MY and sends to the checking module MC.

The checking module MC tests the fourth current local copy E4, and in particular its fourth action A4. Here it is considered that this fourth action A4 does not influence the elements C1 and C3 adjacent the designated element C2.

The operator then instructs the processing module MT to check the influence of a fifth action A5, representative of the second type of action, on the elements C1 and C3 adjacent the designated element C2.

The processing module M2 then accesses the memory MY in order to recover the current local copy E4 that it stores and then integrates into it the fifth action A5 (complementing the fourth action A4), which produces a fifth current local copy shown by a black ellipse E5, which it also stores in the memory MY and sends to the checking module MC.

The checking module MC tests the fifth current local copy E5, and in particular its fifth action A5. It is considered here that this fifth action A5 influences the elements C1 and C3 adjacent the designated element C2. The checking module MC reports this influence to the operator, together with its cause or causes.

The operator then determines a sixth action A6, representative of the second type of action and which he hopes will not influence the adjacent elements C1 and C3. He then instructs the processing module MT to check the influence of this sixth action A6 on the elements C1 and C3 adjacent the designated element C2.

The processing module MT then accesses the memory MY in order to recover the local copy E4 earlier than the current copy E5 which it stores. It then integrates into it the sixth action A6 (complementing the fourth action A4), which produces a sixth current local copy, shown by a gray ellipse E6, which it also stores in the memory MY and sends to the checking module MC.

The checking module MC tests the sixth current local copy E6, and in particular its sixth action A6. Here it is considered that this sixth action A6 does not influence the elements C1 and C3 adjacent the designated element C2.

The operator having successfully determined a series of two corrective actions (A4 and A6) that can remedy a root cause detected by the diagnostic module MD, it can then request the optimization tool OO to effect these two corrective actions (A4 and A6) at the level of the network equipments NE concerned, which here manage the cell C2 (initially designated element).

The optimization tool OO includes for this purpose a standard configuration module MG responsible for converting the received corrective actions into configuration commands addressed to the network equipments NE.

The checking system D of the invention, and in particular its checking module MC and its processing module MT, together with its memory MY and its rules base BR, where applicable, may take the form of electronic circuits, software (or electronic data processing) modules or a combination of circuits and software.

The invention is not limited to the checking system, optimization tool and network management system embodiments described hereinabove by way of example only and encompasses all variants thereof that the person skilled in the art might envisage that fall within the scope of the following claims.

Thus there is described hereinabove an example of a checking system of the invention that receives parameterable element designations and corrective action data from the network operator. However, a variant may be envisaged in which the parameterable element designations and the corrective action data are sent directly to the checking system by the diagnostic module of the optimization tool, where applicable under the control of the operator. In this case, the checking system may supply to the diagnostic module the messages containing the result of the check that it has effected on each corrective action decided on by the latter. The diagnostic module can then be adapted to determine new corrective actions to be checked, instead of preceding corrective actions deemed by the checking system to be liable to influence elements adjacent an initially designated element.

1. A system for checking corrective actions intended for parameterable elements of a radio communication network, comprising an information base for storing primary data representing values of managed parameters of said elements and of a topology of said network, a rules base for storing data representing rules for checking appropriate parameter setting of said elements, processing means for making, in the event of reception of a designation of at least one parameterable element of said network causing a problem in said network and data representing at least one corrective action to be applied to said designated element, a local copy of a portion of said primary data stored in said information base and representing said designated element, elements adjacent thereto and the topology associated with said designated and adjacent elements, and checking means for applying at least certain of said rules to said local copy taking account of each designated corrective action in such a manner as to determine the influence of each designated corrective action on said designated and adjacent elements and to deliver a message including data representing said influence.

2. The system according to claim 1, wherein said processing means send said control means said local copy integrating each designated corrective action.

3. The system according to claim 2, further comprising a memory coupled to said processing means for storing a current local copy consisting of said local copy integrating each designated corrective action.

4. The system according to claim 3, characterized in that, in the event of reception of data representing at least one new corrective action to be applied to said designated elements taking account of said current local copy, said processing means extract said current local copy from said memory in order to integrate each designated new corrective action therein before storing it in said memory and sending it to said checking means in order for them to determine the influence of each designated corrective action on said designated and adjacent elements.

5. The system according to claim 4, wherein, in the event of reception of data representing at least one new corrective action to be applied to said designated element taking account of a local copy earlier than the current local copy, said processing means extract from said memory said local copy earlier than said current local copy in order to integrate each designated new corrective action therein before storing it in said memory and sending it to said control means in order for them to determine the influence of each designated corrective action on said designated and adjacent elements.

6. The system according to claim 3, wherein said processing means store in said memory said local copy initially constituted before integration of each designated corrective action.

7. The system according to claim 6, wherein, in the event of reception of data representing at least one new corrective action to be applied to said designated element taking account of said initial local copy, said processing means extract said initial local copy from said memory in order to integrate each new designated corrective action therein before sending it to said control means in order for them to determine the influence of each designated corrective action on said designated and adjacent elements.

8. The system according to claim 1, wherein said checking means take the form of a rule engine.

9. The system according to claim 1, wherein at least certain of said corrective actions consist of a parameter value to be substituted for a designated element parameter value in a local copy.

10. The system according to claim 1, wherein at least certain of said rules take the form of a condition followed by a corrective action to be effected if said condition is satisfied.

11. An optimization tool for setting parameters of parameterable elements of a radio communication network, said tool comprising an information base for storing primary data representative of the managed parameter values of said elements and of a topology of said network and diagnostic means for delivering designations of a cause of a problem occurring within said network and of at least one parameterable element of said network that is the cause of said problem and a checking system according to any one of the preceding claims coupled to said information base.

12. The tool according to claim 11, further comprising configuration means for generating commands representing at least one corrective action to be applied to said designated element checked by said checking device and causing no collateral damage to elements adjacent said designated elements to correct said cause determined by said diagnostic means.

13. A network management system for a radio communication network, said system comprising an optimization tool according to claim 11.

14. A network management system for a radio communication station, said system comprising an optimization tool comprising an information base for storing primary data representative of values of managed parameters of parameterable elements of said network and of a topology of said network and diagnostic means for delivering designations of a cause of a problem occurring in said network and of at least one parameterable element of said network that is the cause of said problem, which system comprises a checking system according to claim 1 coupled to said optimization tool.
